(19) United States
(12) Patent Application Publication
(10) Pub. No.: US 2023/0246474 A1
(43) Pub. Date: Aug. 3, 2023

(54) Systems and Methods for Batteries

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 18/131,333

(22) Filed: Apr. 5, 2023

Related U.S. Application Data
(60) Provisional application No. 63/329,697, filed on Apr. 11, 2022.

(51) Int. Cl. H02J 7/34; H02J 7/00; G05B 19/042

(52) U.S. Cl. CPC H02J 7/342; H02J 7/0047; H02J 7/00032; H02J 7/0013; G05B 19/042; H02J 2207/20; G05B 2219/2639

(57) ABSTRACT

The assembly of battery cells, battery blocks and battery packs may benefit from a support structure for receiving and positioning battery cells, electronic switches and/or fuses that protect electrodes and/or battery cells or battery blocks from damage, a method for charging and discharging batteries that decreases the amount of energy needed from the power company and cooling system that directs the flow of a coolant to reduce damage from excessive heat.

### BACKGROUND

Embodiments of the present invention relate to batteries including the assembly, manufacture and operation of rechargeable batteries.

A manufacturer of rechargeable batteries may benefit from a support structure (e.g., tray) for assembling battery cells into a battery block.

A battery cell may benefit from electronic switches or physical structures that bypass a failure (e.g., short) to protect proximate electrodes and/or proximate battery cells from damage.

Manufacturers of batteries may benefit from using the current from a charged battery to charge another battery during formation to limit the amount of current that is drawn from the line power (e.g., utility) or returned to the line power.

The failure of a battery cell generally generates a significant amount of heat that can damage proximate battery cells or battery blocks that are functioning properly. A battery pack would benefit from a system that detects imminent failure of a battery cell or battery block and directs additional cooling medium toward the proximate battery cells to protect them from damage.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a perspective view of an example embodiment of a support structure without the case according to various aspects of the present disclosure.

FIG. 2 is a perspective view of an embodiment of a battery cell.

FIG. 3 is a perspective view of an example embodiment of the support structure with battery cells inserted into the bays of the support structure.

FIG. 4 is a side view of the example embodiment of FIG. 3.

FIG. 5 is a perspective view of a support tray.

FIG. 6 is a side view of an example embodiment of a battery pack according to various aspects of the present disclosure.

FIG. 7 is an example embodiment of a battery cell with electronic switches according to various aspects of the current disclosure.

FIG. 8 the battery cell of FIG. 7 with a block diagram of supporting circuits and sensors.

FIG. 9. Is an example embodiment of conductors that electrically connect to electrodes.

FIG. 10 is an example embodiment of a battery cell with fuses according to various aspects of the current disclosure.

FIG. 11 is an example embodiment of a fuse in an operational state according to various aspects of the current disclosure.

FIG. 12 is an example embodiment of a fuse in a burned-out state according to various aspects of the current disclosure.

FIG. 13 is an example embodiment of a battery block with electronic switches according to various aspects of the current disclosure.

FIG. 14 is an example embodiment of a battery block with fuses according to various aspects of the current disclosure.

FIG. 15 is an example embodiment of a charging system according to various aspects of the present disclosure.

FIG. 16 is an example embodiment of a charging circuit of the charging system of FIG. 15.

FIG. 17 is an example embodiment of a system for controlling one or more flows of a cooling medium in the event of imminent failure of a battery block.

### DETAILED DESCRIPTION

Overview

The written description herein includes headings, such as “Overview” above. The headings are for convenience of reference only and are not to be construed as having a legal effect or a limiting construction.

The assembly and manufacturer of batteries may benefit from a support structure adapted to receive battery cells to form a battery block (e.g., block of batteries). A plurality of battery blocks may be assembled to form a battery pack.

At times, electrodes of a battery cell may fail. Generally, a failure causes one or more electrodes of the battery cell to sink a high amount of current (e.g., a current with a high current density) thereby generating a lot of heat. It is possible that the heat may destroy proximate non-failing electrodes. The heat from a failing battery cell may destroy proximate battery cells. Battery cells and battery blocks would benefit from a system that can bypass failing electrodes or battery cells to protect proximate electrodes or battery cells from being damaged.

Battery manufacturers would benefit from a charging system that charges and discharges batteries using a lesser amount of energy drawn from the grid.

Battery pack would benefit from a system that detects imminent failure of a battery cell or a battery block and controls a cooling system to protect battery cells and/or battery blocks proximate to the failing battery cell or battery block from damage.

The provisional patent application No. 63/329,697 filed Apr. 11, 2022 that supports the disclosure of the present application is incorporated herein by reference in its entirety. The nomenclature of this disclosure controls if there any discrepancies with the provisional patent application.

### Support Structure

A support structure for assembling a battery block, also referred to as a support tray or just tray, is configured to receive and position a plurality of battery cells with respect to each other. The support structure holds the battery cells in position with respect to each other. As the battery cells are positioned (e.g., inserted) into the support structure, the support structure is configured to position (e.g., orient) the battery cells so that they may establish serial and/or parallel connections with each other. The support structure increases the ease of assembly of a battery block by providing a location (e.g., space, opening, bay, cavity) into which a battery cell may be placed (e.g., positioned, inserted). The support structure protects the battery cells from harm. The support structure positions the anode terminals and/or the cathode terminals of different battery cells to mechanically and electrically contact each other. The support structure aligns (e.g., positions) any cooling structures (e.g., passages, tubes, fins) attached to or integrated into the battery cells (e.g., terminals of the battery cells) for more efficient flow of a cooling medium (e.g., gas, liquid) for cooling and/or heating the battery cells. The support structure may insulate (e.g., thermally, electrically) the body of one battery cell from the body of another battery cells of the battery block while positioning the terminals of different battery cells to appropriately contact each other. The support structure may protect the battery cells from physical harm. For example, the support structure may protect the battery cells from damage in the event of impact or static electricity.

The support structure enables the assembly of a battery block using battery cells that do not have a container (e.g., package, can, case). In an example implementation of a battery cell that does not have a container, the anode electrodes of the battery cell electrically and mechanically couple to an anode terminal. The cathode electrodes electrically and mechanically couple to the cathode terminal. The chemicals required for the battery cell are positioned between the anode electrodes and the cathode electrodes or on the outer sides of the anode electrodes or cathode electrodes positioned on an edge (e.g., side) of the battery cell. The anode electrodes, the cathode electrodes, the anode terminal, the cathode terminal, and the chemicals form a battery cell that is referred to as a jellyroll because it does not have a container. A jellyroll is configured to be placed in a bay of the support structure. Each jellyroll of a plurality of jellyrolls is configured to be placed in a respective bay of the support structure. The structure (e.g., walls, cover) of the support structure performs the function of the container of a battery cell in addition to the functions discussed above.

In an example embodiment, a support structure 100 includes walls 110-116, 120-126, a central support 130 and a case 340. The walls 110-116, 120-126 are connected to the central support 130 to form bays 150-154 and 160-164. The case 340 is configured to be positioned around the walls 110-116, 120-126 and the central support 130. The case 340 is adapted to enclose the bays 150-154 and 160-164. The walls 110-116, 120-126, the central support 130 and the case 340 are adapted to retain battery cells in the bays 150-154 and 160-164. The case 340 may be positioned around the walls 110-116, 120-126 and the central support 130 before placing battery cells in the bays 150-154 and 160-164 or after battery cells have been placed in the bays 150-154 and 160-164. In an example embodiment, the case 340 is configured to slide over the walls 110-116, 120-126 and the central support 130 to position the case around the walls 110-116, 120-126 and the central support 130. The inner surface of the walls 110-116, 120-126, the central support 130 and the case 340 are adapted to press on the battery cell to retain the battery cell in the bay regardless of whether the battery cell includes a container or not.

The walls 110-116, 120-126, the central support 130 and the case 340 may be formed of any material (e.g., plastic, wood, metal) having sufficient structural strength (e.g., integrity) to position and hold the battery cells 200 in the bays 150-154 and 160-164 of the support structure 100. Using metal as the material of the support structure 100 may require that some type of insulator be placed on the inner surface of the bays. The walls 110-116, 120-126 may be connected to the central support 130 in any manner (e.g., joint, integral, glue). The walls 110-116, 120-126 may be connected to the central support 130 at any location to form the bays 150-154 and 160-164. The bays 150-154 and 160-164 may be of any size, shape, height and/or depth to hold the battery cells 200. Some bays may be larger than other bays.

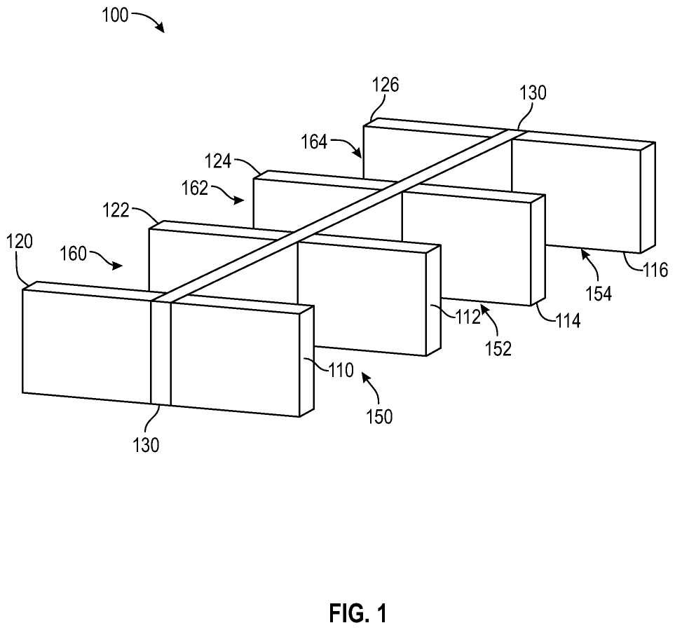

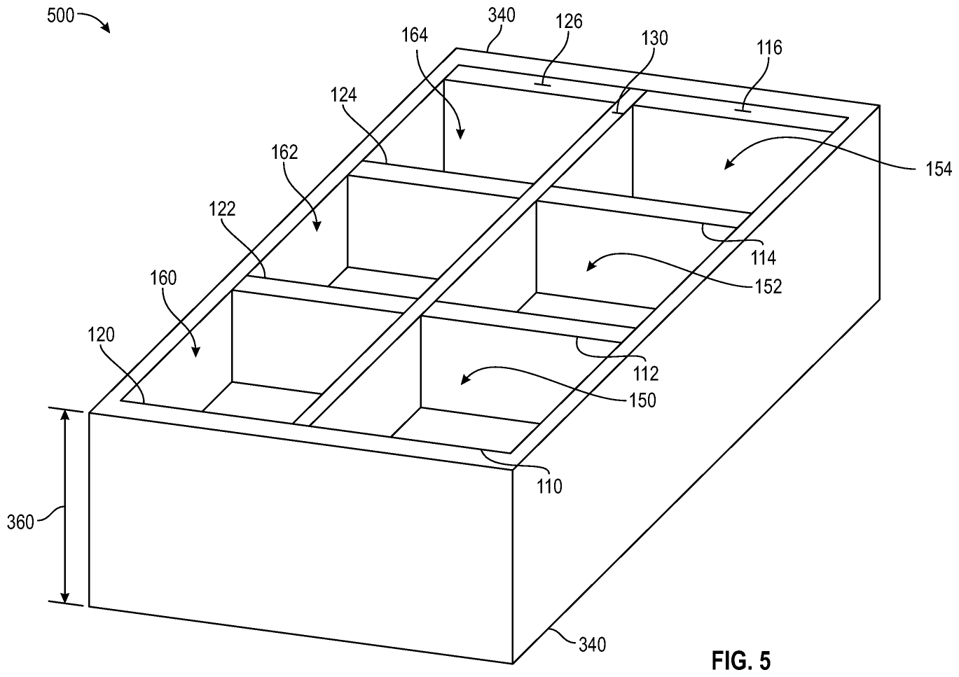

In the example embodiment, as best seen in FIGS. 1 and 5, the central support 130 is formed as a single piece while walls 110-116 and walls 120-126 are formed as single pieces. In another example embodiment, walls 110 and 120, 112 and 122, and so forth are formed as single pieces while central support 130 is formed as multiple pieces positioned between the single piece walls. The walls, the central support and the cover of the support structure 100 may be formed as any number of pieces and connected together in any manner to form the bays 150-154 and 160-164. In another example embodiment, the support structure 100 is formed as a single piece, for example through injection molding. The support structure 100 may have any number of bays. The bays may be positioned with respect to each other in any pattern or orientation. The bays may be any shape (e.g., square, rectangular, octagonal, hexagonal). The bays may be any height.

The case 340 may be positioned (e.g., assembled) around the walls 110-116, 120-126 and the central support 130 in any manner. In an example embodiment, the case 340 slides into place around the walls 110-116, 120-126 and the central support 130 from the top or the bottom with reference to FIGS. 1-5. In another example embodiment, a strip of material is wrapped around the walls 110-116, 120-126 and the central support 130 and joined to itself to form the case 340. The case 340 may include a bottom and/or a top to cover the bottom of the walls 110-116, 120-126 and the central support 130 (e.g., like a floor) or to cover the top of the walls 110-116, 120-126 and the central support 130 (e.g., like a roof, lid). The case 340 that includes a top and a bottom fully encloses the walls 110-116, 120-126, the central support 130, and the battery cells 200 while in position. In an example embodiment, positioning the case 340 around the walls 110-116, 120-126 and the central support 130 stiffens and structurally strengthens the walls 110-116, 120-126 and the central support 130 to increase the amount of structural support they provide to the battery cells when inserted into the bays.

In an example embodiment, as best seen in FIGS. 1 and 3-5, the support structure 100 is formed of a reinforced polymer. The polymer may be reinforced with aluminum slats positioned inside the walls 110-116, 120-126, the central support 130 and/or the case 340. In another example embodiment glass and/or carbon fiber materials are mixed with the polymer used to form the walls 110-116, 120-126, the central support 130 and/or the case 340 to reinforced the polymer. The support structure may be conductive or, preferably, non-conductive.

An assembled support structure 100, in particular a support structure 100 in which the case 340 includes a bottom, may also be referred to as a support tray (e.g., 500).

### Battery Cell

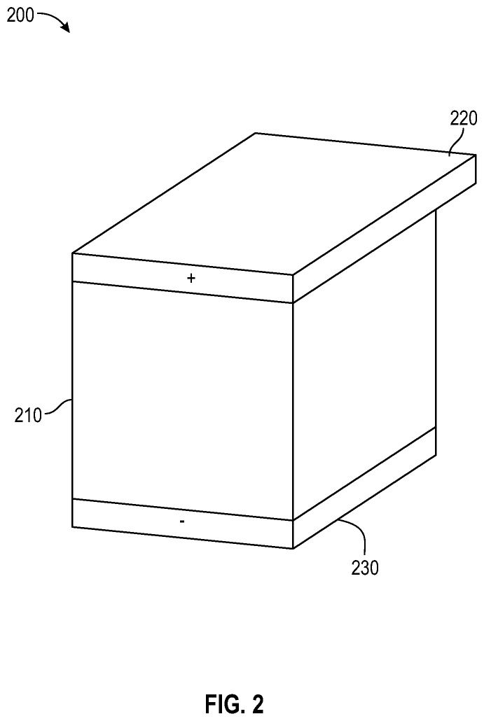

The battery cell 200, as best shown in FIGS. 2-4, includes, inter alia, anode electrodes (not shown), cathode electrodes (not shown), and chemicals (not shown) positioned inside the container 210 between the anode electrodes and the cathode electrodes. The anode terminal 220 couples to the anode electrodes. The cathode terminal 230 couples to the cathode electrodes. Removing the container 210 would leave the jellyroll. The anode terminal 220 and the cathode terminal 230 may also mechanically couple to the container 210. The battery cell 200 may be charged to store electrical energy. The battery cell 200 may be discharged to provide electrical energy. One battery cell 200 may be connected to any number of other battery cells 200 in parallel and/or series connections. The anode terminal 220 and/or the cathode terminal 230 may have any shape suitable for electrically connecting the battery cells 200 to each other once positioned in the support structure 100.

The support structure 100 combined with two or more battery cells 200 positioned in respective bays 150-154 and 160-164 may be referred to as a battery block 300.

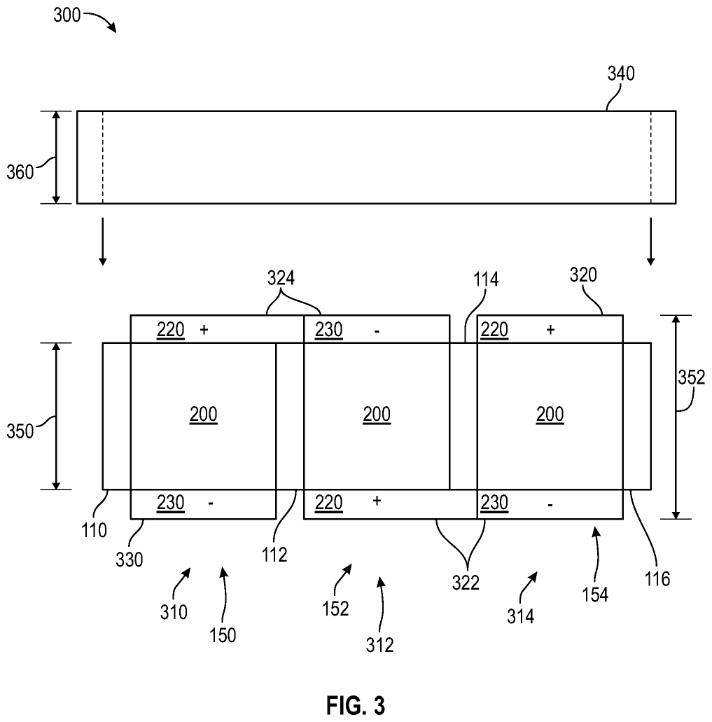

In an example embodiment, each battery cell 200, with or without container 210, is adapted to be positioned in (e.g., placed in, inserted into) one of the bays 150-154 and 160-164 respectively. As the battery cells 200 are inserted into the bays 150-154 and 160-164, the battery cells 200 may be alternately oriented (e.g., flipped, turned over, rotated) to connect the battery cells 200 in series. For example, referring to FIG. 3, the battery cell 310 positioned in the bay 150 is positioned with the anode terminal 220 upward (e.g., with respect to the page) while the battery cell 312, positioned in the bay 152, is positioned with the anode terminal 220 downward. The anode terminal 220 is configured (e.g., in shape, size, length, width) to contact the cathode terminal 230 of an adjacent bay. So, the anode terminal 220 of the battery cell 310 contacts the cathode terminal 230 of the battery cell 312 thereby electrically connecting the battery cells 310 and 312 in series.

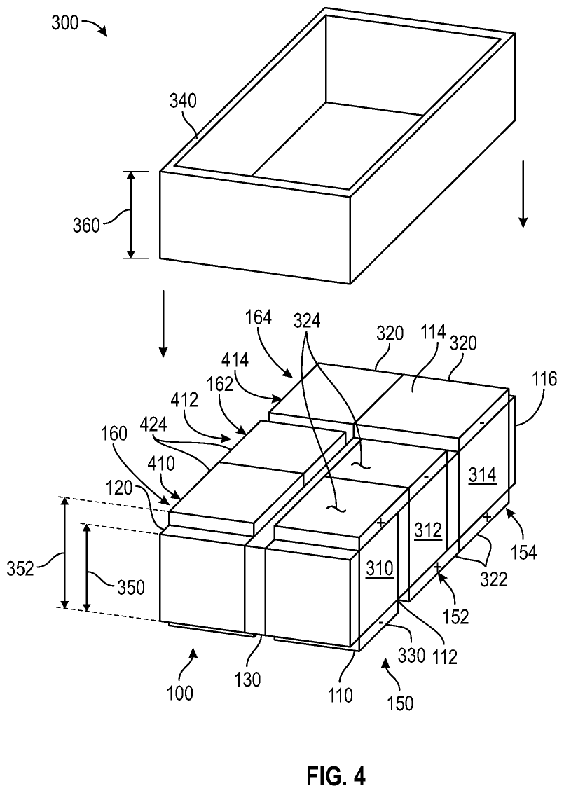

In an example embodiment, as best shown in FIGS. 3-4, the battery cells 310, 312 and 314, 410, 412 and 414 are connected in series so that the cathode terminal 230 of battery cell 310 operates as the cathode of the battery block 300 and the anode terminal 220 of the battery cell 410 operates as the anode of the battery block 300. The electrical connection between battery cells 310 and 312, between battery cells 312 and 314, between battery cells 314 and 414, between battery cells 414 and 412 (not shown), and between battery cells 412 and 410 are intermediate nodes in the series connection. The intermediate nodes 320, 322, 324 and 424 are identified in FIG. 4.

In another example embodiment, the battery cells 200 are positioned in the bays 150-154 and 160-164 so that the anode terminal 220 of each battery cell 200 is oriented in the same direction (e.g., upward, downward) and the cathode terminal 230 of each battery cell 200 is oriented in the same direction (e.g., downward, upward). The anode terminals 220 of each the battery cells 200 are shaped to physically contact the anode terminal 220 of one or more proximate battery cells 200 to connect the anode terminal 220 of all of the battery cells 200 to each other. The cathode terminals 230 of each the battery cells 200 are shaped to physically contact the cathode terminal 230 of one or more proximate battery cells 200 to connect the cathode terminal 230 of all of the battery cells 200 to each other. Because all of the anode terminals are electrically connected to each other and all of the cathode terminals are electrically connected to each other, the battery cells 200 are connected in parallel.

The battery cells 200 positioned in the support structure 100 may have any number of parallel and series connections. For example, in an example embodiment, the battery cells 310, 312 and 314 connect in series with each other and the battery cells 410, 412 and 414 also connected in series with each other. However, at least one anode terminal 220 and one cathode terminal 230 of the battery cells 310, 312 and 314 connect to at least one anode terminal 220 and one cathode terminal 230 of the battery cells 410, 412 and 414 respectively thereby connecting the battery cells 310, 312 and 314 and the battery cells 410, 412 and 414 in parallel with each other.

### Support Tray for Jellyrolls

As discussed above, anode electrodes, cathode electrodes, the anode terminal 220 and the cathode terminal 230 may be assembled without container 210 to form a jellyroll. Jellyrolls may be inserted into the bays 150, 152, 154, and 160, 162, 164 respectively of the support tray 500. The walls 110-116, 120-126, the central support 130 and the case 340 surround the jellyroll to position and protect the jellyrolls. As discussed above, in an example embodiment, the orientation of the jellyrolls may be alternated in the bays 150-154 and 160-164 of the support tray 500 to connect the jellyrolls in series. In another embodiment, the jellyrolls may be inserted into the bays 150, 152, 154, and 160, 162, 164 so that they connect in parallel. In another example embodiment, the jellyrolls may be oriented in bays 150-154 and 160-164 so that some of the jellyrolls connect in series while the series connected jellyrolls connected in parallel.

Once the jellyrolls, or battery cell with containers, are inserted into the support tray 500, the battery cells in combination with the support tray 500 form a battery block 300. In an example embodiment, the case 340 used to enclose the walls 110-116 and 120-126, the central support 130 and the jellyrolls includes a top and a bottom to fully enclose the jellyrolls to retain the chemicals in the jellyrolls. The top and the bottom (not shown) of the case 340 may include openings to allow access to the anode and the cathode of the battery block 300.

The case 340 may be hermetically sealed to the end portions or other parts of the walls 110-116 and 120-126 and/or the central support 130. The top and the bottom may be hermetically sealed to the walls 110-116, 120-126 and/or the central support 130. Hermetically sealing the parts of the support tray 500 configures the bays to contain the chemicals of the individual jellyrolls in their respective bays.

### Battery Pack

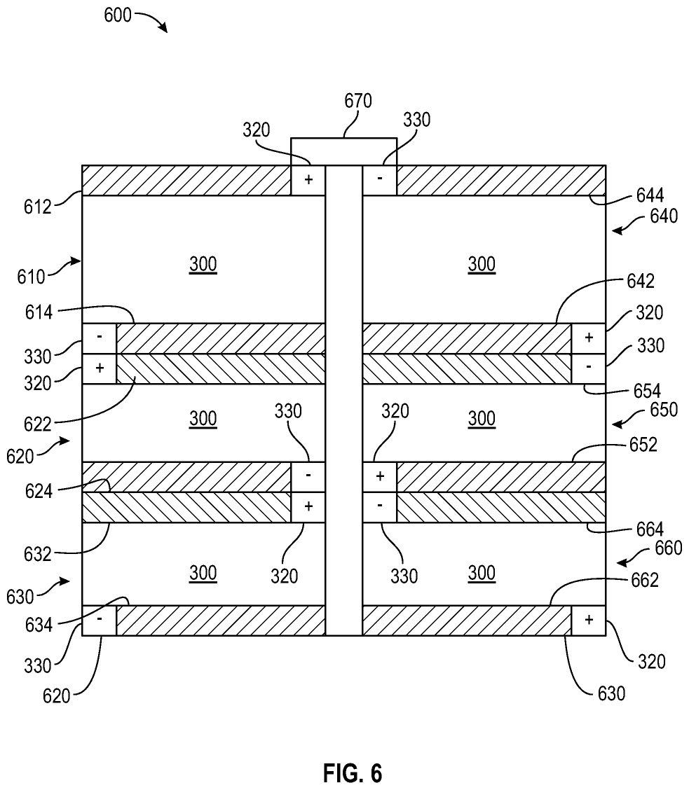

Two or more battery blocks that are electrically, and possibly physically, coupled to each other form a battery pack. In an example embodiment, a plurality of battery blocks 300, as best shown in FIG. 6, are physically and electrically coupled to each other to form the battery pack 600. In this example embodiment, the battery blocks 300 are electrically connected in series to each other. In another example embodiment, the battery blocks 300 are electrically connected to each other in parallel with each other to form the battery pack 600. In another example embodiment, a first group of battery blocks 300 are electrically connected to each other in series, a second group of battery block 300 are electrically connected to each other in series, and the battery blocks 300 of the first group are electrically connected in parallel to the battery block 300 of the second group.

Connectors, such as connector 670 may be used to connect between the anode and/or cathode terminals of the battery blocks 300 to form serial and/or parallel connections. The anode terminal or cathode terminal of any one or more of the battery blocks 300 may be used as the anode terminal or the cathode terminal respectively of the battery pack 600. A connector may be used as the anode terminal or the cathode terminal of the battery pack 600.

### Assembly of Battery Block

The parts of a battery block (e.g., 300) may be assembled to form the battery block in any order that makes sense. In a first example, the support structure 100 is formed by coupling the walls 110-116 and 120-126 to the central support 130 to form the bays 150-154 and 160-164. The jellyrolls or battery cells 200 with containers are positioned and oriented in the bays 150-154 and 160-164 to make the desired series and/or parallel electrical connections. The case 340 slides over and around the support structure 100 and the jellyrolls or battery cells 200 to encircle the walls 110-116 and 120-126, the central support 130, and the jellyrolls or battery cells 200. A top and a bottom may be added.

In another example, the central support 130 is positioned in and physically coupled to the case 340. The walls 110-116 and 120-126 are positioned in and physically coupled to the case 340 and the central support 130. The bottom (not shown) is positioned under the walls 110-116 and 120-126 and the central support 130 and physically coupled thereto. The jellyrolls or the battery cells 200 are positioned and oriented in the bays 150-154 and 160-164. The top is placed over and physically coupled to the walls 110-116 and 120-126 and the central support 130.

### Assembly of Battery Pack

Battery Blocks may be positioned in any position relative to each other to form the battery pack. The battery blocks may be physically coupled to one or more other battery blocks to form the battery pack. One or more battery blocks or one or more groups of battery blocks may be electrically connected to each other in series or in parallel to form the battery pack.

A support structure may be used to receive battery blocks to form a battery pack. The support structure for forming a battery pack may be similar in structure to the support structure 100/500. A battery pack may be enclosed in protective material, such as case 340, to further structurally hold the battery blocks in position and/or to protect the battery blocks.

### Battery Cell Bypass

A short circuit between an anode electrode and a cathode electrode of a battery cell results a short circuit current flowing between the anode electrode and the cathode electrode. Generally, a short circuit current is a large current (e.g., high amperage, high current density) that generally increases, in a runaway manner, until the anode electrode and cathode electrode are destroyed (e.g., melted). The short circuit current also results in an increase in the temperature in the area around the fault and an increase in the temperature of the battery cell. The increase in temperature tends to affect electrodes proximate to the failing electrode so that the proximate electrodes also short out thereby causing a runaway (e.g., unstoppable, uncontrollable) failure in the battery cell and ultimately the destruction of the battery cell.

Battery cells may be protected from runaway destruction by disconnecting the anode and/or cathode electrodes that are shorted out from their respective anode terminal and cathode terminal. Disconnecting the shorted anode and cathode electrodes from their respective terminals stops the flow of the destructive current through the battery cell thereby protecting the remaining anode and cathode electrodes from destruction. An electrode may be connected to its terminal through an electronic switch or through a fuse. Upon detecting a short circuit between an anode electrode and a cathode electrode, the electronic switch or the fuse may disconnect the anode electrode and/or the cathode electrode from their respective anode terminal and cathode terminal thereby precluding the destructive short circuit current.

Batteries may be connected to each other to form a battery block. The terminals of the battery block may be referred to as a busbar. A battery block has an anode busbar and a cathode busbar. The one or more terminals (e.g., anode, cathode) of the battery cells of the battery block may be connected to the anode busbar or the cathode busbar via an electronic switch or a fuse. The electronic switch or the fuse may stop the flow of a short circuit current through a failing battery block to preclude the destruction caused by the short circuit current. The electronic switch or the fuse disconnects the failing battery block from anode busbar and/or the cathode busbar to stop the flow of the short circuit current.

Battery Cell with Electronic Switch Bypass

In a first example embodiment, a battery cell 700 includes anode electrodes 730-738, cathode electrodes 760-766, chemicals between and around the electrodes (not shown), electronic switches 720-728 and 750-756, an anode terminal 710 and a cathode terminal 740. The anode electrodes 730-738 electrically connect to the anode terminal 710 through the electronic switches 720-728 respectively. The cathode electrodes 760-766 electrically connect to the cathode terminal 740 through electronic switches 750-756 respectively. When the electronic switches 720-728 and 750-756 are closed (e.g., able to pass current), the anode electrodes 730-738 and the cathode electrodes 760-766 are electrically connected to the anode terminal 710 and the cathode terminal 740 respectively. When any electronic switch is open (e.g., cannot pass current), the anode electrode 730-738 or the cathode electrode 760-766 connected to the open switch is disconnected from the anode terminal 710 or the cathode terminal 740 respectively. The electronic switches 720-728 and 750-756 may be operated independently of each other so that any combination of switches may be open or closed there by disconnecting or connecting an electrode to its respective terminal.

The electronic switches 720-728 and 750-756 may be implemented using any type of technology. The electronic switches 720-728 and 750-756 are configured to carry, when closed, the amount of current that passes through the electrode or electrodes to which it is attached. One switch (e.g., 720) may be connected to a single electrode (e.g., 730) or to two or more electrodes. One switch may control the current through a group of two or more proximate electrodes. For example, switch 722 could be eliminated and switch 720 could control the current through anode electrode 730 and anode electrode 732. The anode electrodes could be grouped into anode electrode groups with one switch controlling the current through all anode electrodes of the group. The same could be implemented for the cathode electrodes.

In another example embodiment, only the anode electrodes, or groups of anode electrodes, are controlled by electronic switches 720-728. Electronic switches 750-756 are omitted. Since an anode electrode is positioned on each side of a cathode electrode, current from a failing cathode electrode may be stopped or limited by shutting off the switches of the anode electrodes on each side of the failing cathode electrode. In another example embodiment, only the cathode electrodes, or groups of cathode electrodes, are controlled by electronic switches 750-756 while the electronic switches 720-728 are omitted.

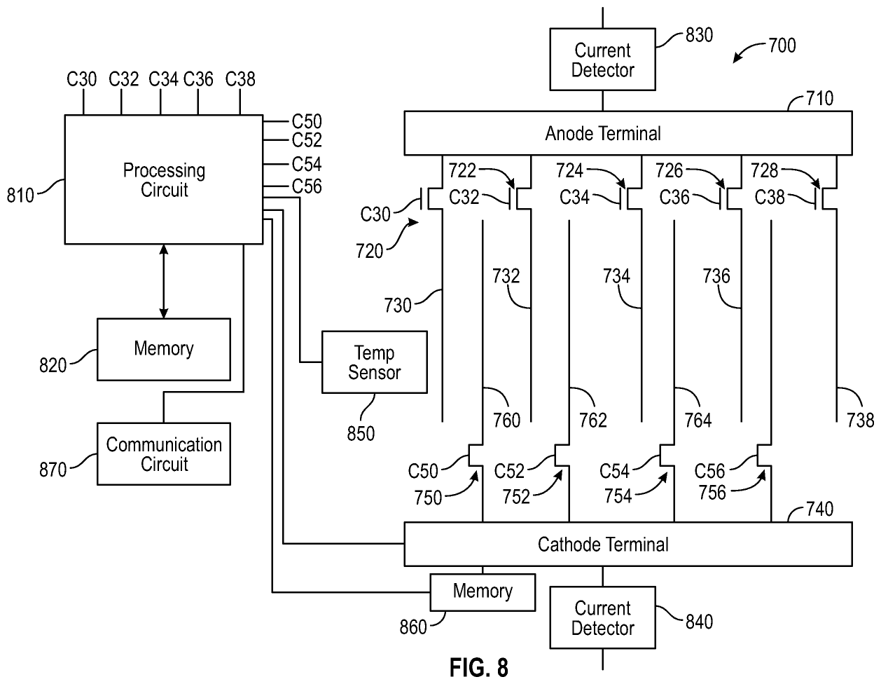

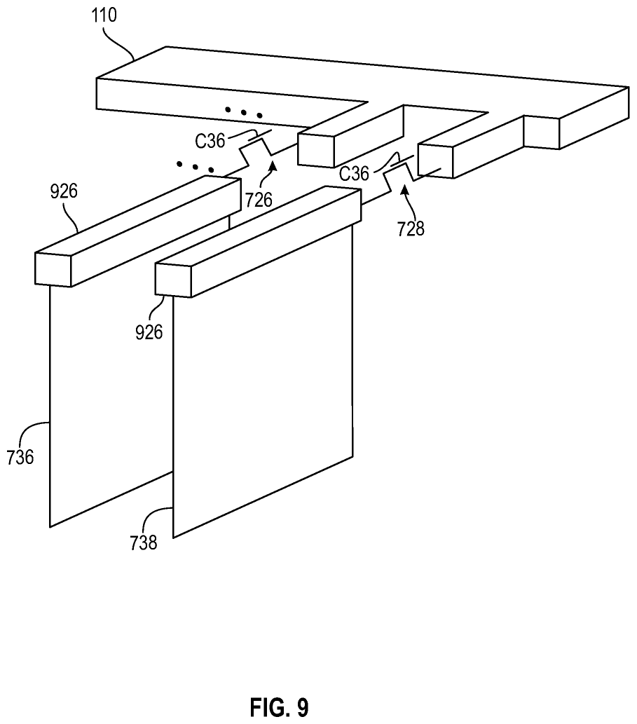

The electronic switches 720-728 and 750-756 shown in FIG. 8 are MOSFET transistors. Any type of switch using any type of technology (e.g., FET, BJT, IGBT) may be used. The switches may be physically implemented in any manner. The switches may be packaged in any type of package. The conductors that carry current from the switch (e.g., C30) to the electrode (e.g., 730) are configured to carry the magnitude of current that will be supplied by the electrode while the battery cell is a normal use or been recharged. For example, as best seen in FIG. 9, conductor 926 carries current to and from the electrode 736. The conductor 926 is positioned along an entire width of the electrode 736 to reduce resistance. Current flowing from the anode terminal 710 to the electrode 736 flows through the electronic switch 728 into the conductor 926 then to the electrode 736. Current flowing from the electrode 736 to the anode terminal 710 flows from the electrode 736 to the conductor 926 through the electronic switch 728 to the anode terminal 710. The switches may be packaged in any type of package (e.g., DIP, SOIC, PGA). The switches may be mounted on a printed circuit board (PCB) that is positioned on the battery cell, such as the top for the anode electrodes and the bottom for the cathode electrodes referring to FIG. 8.

Conductors (e.g., traces, wires) connect the electronic switches 720-728 and 750-756 (e.g., the FET gates) to processing circuit 810. The processing circuit 810 controls whether a switch is open or closed. The battery cell 700 includes current detectors 830 and 840 configured to measure the magnitude of the current that flows into and/or out of the anode terminal 710 and the cathode terminal 740 respectively. The current detectors 830 and 840 report the measured current to the processing circuit 810. The current detectors 830 and 840 monitor the current continuously or at regular intervals and report to the processing circuit 810 in real-time or for each regular interval. When the processing circuit 810 detects a flow of current greater than a threshold, the processing circuit may turn on and off the electronic switches 720-728 and 750-756 in any sequence to determine which electrode is or which electrodes are the cause of the high current. After the processing circuit 810 detects the electrode or electrodes causing the fault, the processing circuit 810 opens the switch or switches associated with the electrode or electrodes causing the fault to stop the flow of current to and from the electrode or electrodes.

The battery cell 700 may further include a temperature sensor 850. The temperature sensor 850 detects the temperature of the battery cell continuously or at regular intervals and reports the temperature of the battery cell 700 to the processing circuit in real-time or for each regular interval. The temperature sensor 850 may be a plurality of temperature sensors positioned at various physical locations of the battery cell 700. When the processing circuit 810 detects a temperature greater than a threshold, the processing circuit may turn the electronic switches 720-728 and 750-756 on (e.g., close) or off (e.g., open) in any sequence to determine a potential location of the cause of the increased temperature. The processing circuit 810 may use the data from the current detector 830, the current detector 840 and the temperature sensor 852 monitor the health and the effect of switching the switches C30-C38 and C50-C56 on the current and the temperature of the battery cell 700.

Once a fault is detected and a switch is turned off (e.g., open), the processing circuit 810 may store information regarding the cause of the fault. In other words, the processing circuit 810 may store which electrodes were the cause of the fault, in the memory 820. Prior to using a battery, the processing circuit reads the switch configuration from the memory 820 and sets the switches in accordance with the data from the memory 820, so that failing electrodes are cut off prior to use of the battery cell 700.

The processing circuit 810 may communicate data, such as current, temperature and failed electrodes, to a destination via communication circuit 870. The communication circuit 870 includes any type of electronic device for communicating, such as a bus and/or a wireless communication circuit.

In an example embodiment, the battery cell 700 is tested after manufacture. In the event that failing electrodes are detected during test, the battery cell need not be scrapped. The identity of the failing electrodes and the switches associated with the failing electrodes may be stored in memory 860. When the battery cell is included in a battery block or a battery pack, the processing circuit reads the data from memory 860. The processing circuit 810 stores the data from the memory 860 in the memory 820. The processing circuit 810 may then set the switches C30-C38 and C50-C56 in accordance with the data from memory 860. Setting the switches in accordance with the data from memory 860 turns off the switches for the electrodes that were detected as failing electrodes after manufacture. Using data from the memory 860 allows the battery to be used because the failed electrodes are turned off. However, the energy storage capacity of the battery cell is less than the capacity of a battery cell that has no failing electrodes.

In another example embodiment, battery cell 700 includes anode electrodes 730-738, cathode electrodes 760-766, chemicals between and around the electrodes (not shown), anode terminal 710 and cathode terminal 740. The anode electrodes 730-738 electrically connect to the anode terminal 710 through the electronic switches 720-728 respectively. The cathode electrodes 760-766 connect directly to the cathode terminal 740 and the electronic switches 750-756 are omitted.

In another example embodiment, battery cell 700 includes anode electrodes 730-738, cathode electrodes 760-766, chemicals between and around the electrodes (not shown), anode terminal 710 and cathode terminal 740. The cathode electrodes 760-766 electrically connect to the cathode terminal 740 through the electronic switches 750-756 respectively. The anode electrodes 730-738 connect directly to the anode terminal 710 and the electronic switches 720-728 are omitted.

The battery cell 700 may be monitored to determine whether a failure of the battery cell is imminent. Generally, failure of the battery cell results from a short between an anode electrode and a cathode electrode. A short between an anode electrode and a cathode electrode causes a high current to flow between the anode electrode and the cathode electrode. For example, a short between anode electrode 732 and cathode electrode 762 results in a high current that flows through the anode terminal 710, electronic switch 722, the anode electrode 732, the cathode electrode 762, electronic switch 752, and the cathode terminal 740. Opening the electronic switch 722 and/or the electronic switch 752 disconnects the anode electrode 732 and/or the cathode electrode 762 from the anode terminal 710 and/or the cathode terminal 740 respectively. Opening the electronic switch 722 and/or the electronic switch 752 stops the flow of the current through the short circuit between the anode electrode 732 and the cathode electrode 762 thereby bypassing the short circuit (e.g., fault). Bypassing the short circuit causes the short circuit current to stop flowing because the circuit between the anode electrode and the cathode electrode that are shorted together is opened.

Opening one or more switches to bypass the fault allows the battery cell 700 to continue functioning, although with fewer electrodes and thereby less capacity. Opening one or more switches to bypass the fault also stops the flow of the short circuit current thereby protecting the battery cell from likely destruction by thermal runaway.

Any method may be used to detect an imminent failure of a battery cell. A fault may be detected on an electrode level and/or at a battery cell level. Detecting a fault on an electrode level includes detecting a voltage, a current, and/or a temperature between adjacent anode and cathode electrodes. If a fault is detected between adjacent anode and cathode electrodes, the switches associated with the electrodes may be opened to bypass the anode and cathode electrodes thereby bypassing the fault.

A fault may be detected on a battery cell level by detecting a voltage across, a current through and/or a temperature of the battery cell. If a fault is detected in a battery cell, a controller may open all of the electronic switches (e.g., 720-728, 750-756). The controller may then successively close electronic switches to detect the anode and cathode electrodes involved in the fault. Once the anode and cathode electrodes involved in the fault have been identified, the electronic switches associated with the anode and cathode electrodes may be opened and remain open to bypass the electrodes associated with the fault while leaving the other electronic switches closed and their associated electrodes operating.

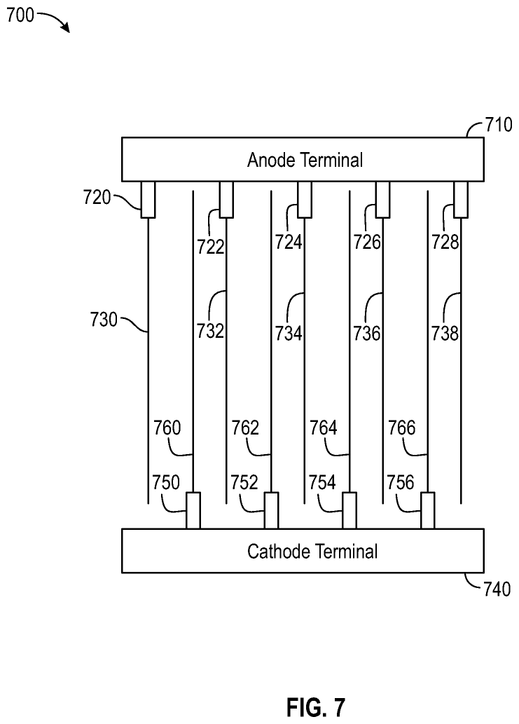

Any type of electronic switch may be used to allow or disallow current to flow from a terminal to an electrode. In an example implementation, best shown in FIG. 7, a respective electronic switch (e.g., 720-728, 750-756) may be positioned in series with (e.g., between) the anode terminal 710 and each anode electrode 730-738 and the cathode terminal 740 and each cathode electrode 760-766. In another example embodiment, each electronic switch may be adapted to couple to two or more electrodes so that one electronic switch controls the current through the two or more electrodes.

Battery Cell with Fuses

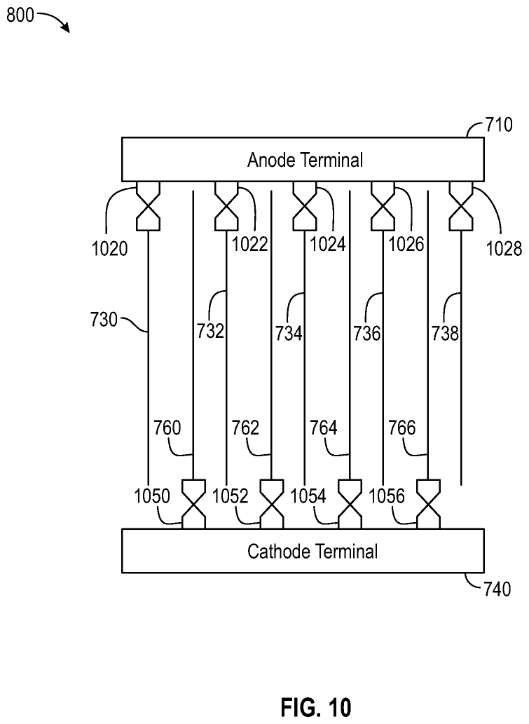

In a second example embodiment, as best shown in FIG. 10, battery cell 800 includes anode electrodes 730-738, cathode electrodes 760-766, chemicals between and around the electrodes (not shown), anode terminal 710 and cathode terminal 740. The anode electrodes 730-738 electrically connect to the anode terminal 710 through fuses 1020-1028 respectively. The cathode electrodes 760-766 electrically connect to the cathode terminal 740 through fuses 1050-1056 respectively.

The fuses 1020-1028 and 1050-1056 have two states. When the fuse is operational (e.g., operational state), a current may flow through the fuse. For example, when fuse 1020 is operational, a current may flow between the anode terminal 710 and the anode electrode 730. When a fuse is burned out (e.g., burned-out state, blown, melted), no current can flow through the fuse. For example, when fuse 1020 is burned out, no current may flow between the anode terminal 710 and the anode electrode 730.

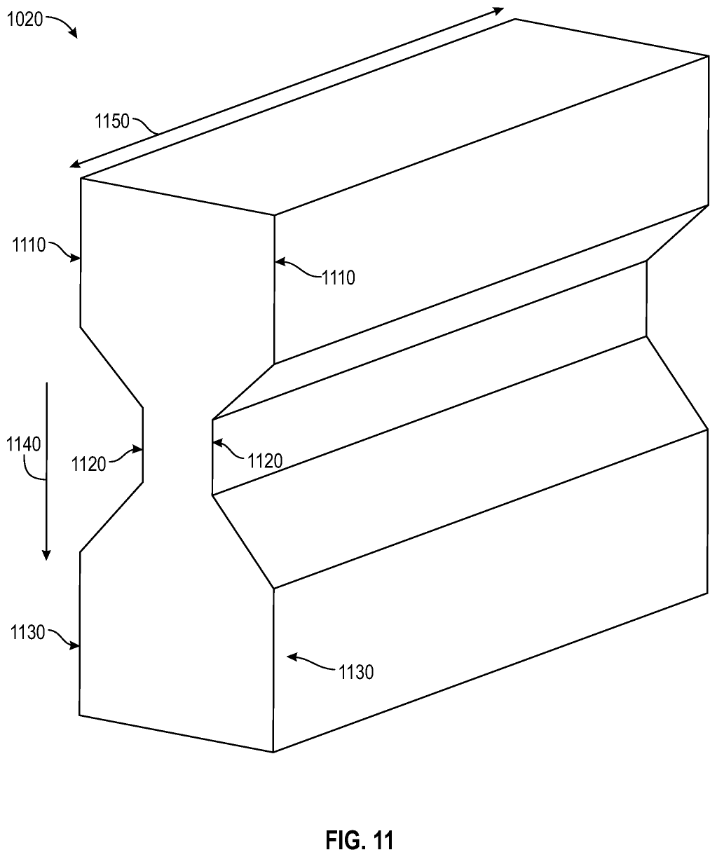

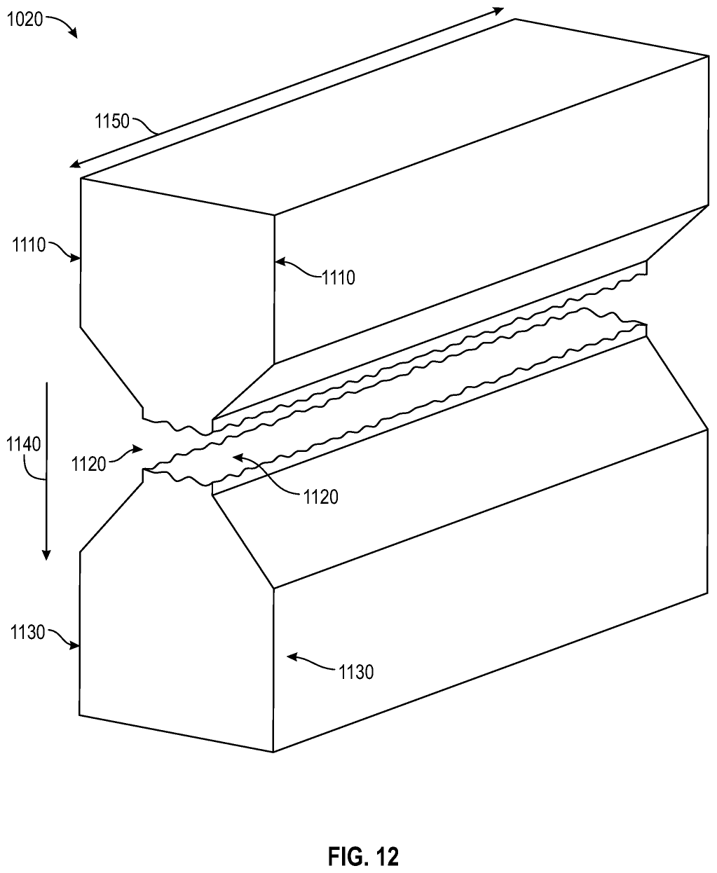

A close-up of an example embodiment of the fuse 1020 is shown in FIG. 11. The other fuses 1022-1028 and 1050-1056 are the same as fuse 1020. In the operational state, the limiter 1120 is intact (e.g., present, not open, not melted) so the current 1140 may flow between the tab 1110 and the tab 1130 of the fuse 1020. In the burned-out state, the limiter 1120 is missing from the fuse 1020, so the current 1140 cannot flow between the tab 1110 and the tab 1130. The physical properties (e.g., width, length, depth, material type) of the limiter 1120 determine the amount of current 1140, in particular a maximum amount of current, that can pass between the tab 1110 and the tab 1130. While the current that flows between the tab 1110 and the tab 1130 is less than the maximum amount (e.g., density, threshold), the limiter 1120 remains in position and the fuse 1020 remains in the operational state. When the current 1140 that flows between the tab 1110 and the tab 1130 is greater than the maximum amount, the current 1140 causes the limiter 1120 to heat up and melt, as best seen in FIG. 12, thereby destroying the limiter 1120 and causing an open circuit through which the current 1140 cannot pass. The melting of the limiter 1120 causes the fuse 1020 to enter the burned-out state.

The width 1150 of the fuse 1020 may be fairly wide to decrease the resistance between the anode terminal 710 and the anode electrode 730. In an example embodiment, the width 1150 is at least 50% of the width of the anode electrode 730. As shown in FIG. 10, the width of anode electrode 730 goes into the page. In another example embodiment, the width 1150 is about the same as the width of the anode electrode 730. In another example, the width 1150 is greater than the width of the anode electrode 730. In another example embodiment, the width 1150 of the fuse 1020 is 10% or less than the width of the anode electrode 730; however, multiple fuses 1020 are connected to the anode electrode 730 along the width of the anode electrode 730. The multiple fuses 1020 along the width of the anode electrode 730 operate in parallel to provide current flow to and from anode electrode 730.

In a preferred embodiment, the width of the fuse 1020 is about the same width as the anode electrode 730. Further, multiple electrodes (e.g., 730A, 730B, 730C, so forth, not shown) connect to the fuse 1020. In an example embodiment, between 10 and 50 electrodes connect to the fuse 1020. In manufacturing, the multiple electrodes may be welded to the fuse 1020.

In an example embodiment, the fuse 1020 is formed from the same material as the electrode. In another example embodiment, the fuse 1020 is formed of a different material than the electrode, but the fuse 1020 is conductive to allow the flow of current to and from the electrode or electrodes while the fuse 1020 is in the operational state.

The limiter 1120 enters the burned-out state when the current 1140 reaches an amount that corresponds to a failure of the electrode or electrodes to which the fuse 1020 is connected. As the current 1140 increases to a magnitude that is greater than the maximum threshold, the limiter 1120 may not burn out (e.g., melt) along its entire width 1150 at the same time. Instead, portions (e.g., sections) of the limiter 1120 will burn out, which will increase the current density through the remaining portions of the limiter 1120 until finally the limiter 1120 is completely gone as shown in FIG. 12. As the magnitude of the current flowing through the fuse 1020 exceeds the maximum threshold, the limiter 1120 begins to heat and with time or increased current flow, the limiter 1120 melts. Because the current density incident to a failure causes the limiter 1120 to enter the burned-out state, there is no need for a controller (e.g., processing circuit) as with electronic switches. The limiter 1120 is either intact or in the burned-out state. Once the limiter 1120 of the fuse 1020 is gone (e.g., burned-out, melted), it is irreparable and no current can pass to or from the anode electrode 730.

As shown in FIG. 10, the fuses 1020-1028 and 1050-1056 protect individual electrodes that experience failure by burning out to stop the flow of current and thereby bypassing the failure. Disconnecting a failing electrode from its terminal stops heat buildup in electrode that destroys proximate electrodes that are functioning. As discussed above with respect to switches, fuses may connect to individual electrodes or a group of adjacent electrodes of the same type (e.g., anode, cathode) may connect to a single fuse. The fuses that burn out are only those fuses in series with a failing electrode, so once the fuse enters the burn-out state, the electrode or electrodes responsible for (e.g., that caused) the failure are removed from the circuit (e.g., bypassed). The fuses that do not burn out allow the electrodes that are still operational to continue to function. The fuses bypass failing electrodes while leaving the remaining electrodes operational. When a failure occurs, the failing electrodes are removed from the circuit thereby halting runaway thermal destruction of other electrodes or of the battery cell 800. However, burning out one or more fuses 1020-1028 and 1050-1056 results in diminishing the charge capacity of the battery cell 800.

In another example embodiment, battery cell 800 includes anode electrodes 730-738, cathode electrodes 760-766, chemicals between and around the electrodes (not shown), anode terminal 710 and cathode terminal 740. The anode electrodes 730-738 electrically connect to the anode terminal 710 through the fuses 1020-1028 respectively. The cathode electrodes 760-766 connect directly to the cathode terminal 740 and the fuses 1050-1056 are omitted.

In another example embodiment, battery cell 800 includes anode electrodes 730-738, cathode electrodes 760-766, chemicals between and around the electrodes (not shown), anode terminal 710 and cathode terminal 740. The cathode electrodes 760-766 electrically connect to the cathode terminal 740 through the fuses 1050-1056 respectively. The anode electrodes 730-738 connect directly to the anode terminal 710 and the fuses 1020-1028 are omitted.

### Battery Block

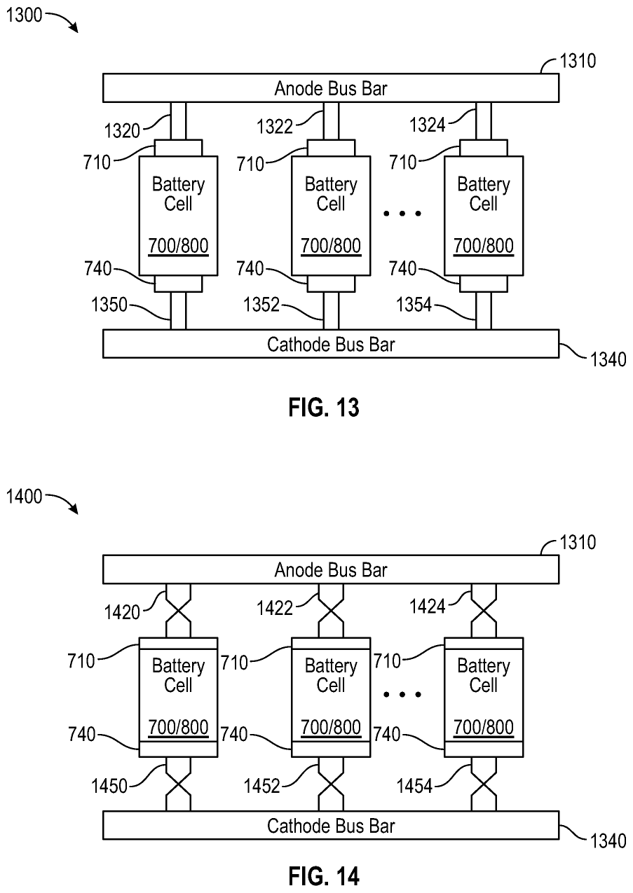

As discussed above, electronic switches and/or fuses may protect the individual electrodes or groups of electrodes of a battery cell. Electronic switches and/or fuses, as best shown in FIGS. 13 and 14, may also be used to protect the battery cells that form a battery block. In an example embodiment, referring to FIG. 13, the battery block 1300 includes a plurality of battery cells 700/800, an anode busbar 1310, a cathode busbar 1340, and electronic switches 1320-1324 and 1350-1354. The anode terminals 710 of the battery cells 700/800 couple to the anode busbar 1310 via the electronic switches 1320-1324 respectively. The cathode terminals 740 of the battery cells 700/800 couple to the cathode busbar 1340 via electronic switches 1350-1354. In another example embodiment, the electronic switches 1320-1324 are omitted and the anode terminals 710 connect directly to the anode busbar 1310. In another example embodiment, the electronic switches 1350-1354 are omitted and the cathode terminals 740 connect directly to the cathode busbar 1340.

In another example embodiment, the electronic switches 1320-1324 and 1350-1354 are omitted so that the anode terminals 710 of the battery cells 700/800 connect directly to the anode busbar 1310 and the cathode terminals 740 of the battery cells 700/800 connect directly to the cathode busbar 1340. Electronic switches or the fuses inside the battery cells 700/800 protect against excessive current. In another example embodiment, only one electronic switch 1320-1324 or 1350-1354 is used per battery cell; however, the battery cells do not include internal electronic switches or fuses, so current protection is provided by the electronic switches 1320-1324 or 1350-1354 and not internally inside the battery cells. In another example embodiment, the electronic switches 1320-1324 and 1350-1354 are used so that each battery cell is protected by two electronic switches; however, the battery cells do not include internal electronic switches or fuses.

As shown above with respect to electronic switches that protected electrodes or groups of electrodes, the electronic switches 1320-1324 and 1350-1354 are also controlled by a processing circuit (e.g., 810). The processing circuit may use the current detectors 830 and 840 associated with each individual battery cell to detect the current flowing through the battery cell and/or the battery block 1300 may include current detectors (not shown). The battery block may include one or more current detectors per battery cell for detecting current flow between the anode busbar 1310 and the anode terminal 710 or the cathode busbar 1340 and the cathode terminal 740 of each battery cell or one current detector per battery cell. The processing circuit may further use the temperature sensor 850 of each individual battery cell to detect the temperature of the battery cell and/or the battery block 1300 may include temperature sensors (not shown).

When an imminent failure or a failure in progress of one or more of the battery cells is detected, one or more electronic switches 1320-1324 and/or electronic switches 1350-1354 are opened to stop the flow of current through the battery cell 700/800 thereby stopping the progress of the failure of the battery cell and protecting the adjacent battery cells from destruction. For example, in the event of failure of the middle battery cell 700/800 shown in FIG. 13, a controller (e.g., processing circuit), not shown, may open electronic switch 1322 and/or electronic switch 1352 to stop the flow of current through the battery cell. Stopping the flow of current through the battery cell stops a potentially destructive rise in the temperature and current flow of the battery cell thereby protecting the adjacent battery cells from destruction.

Because the dimensions of the battery block are greater the dimensions of an individual battery cell, in particular an electrode, electronic switches may be selected from off-the-shelf components. The electronic switches may be integrated into a PCB that also holds the processing circuit.

In another example embodiment, referring to FIG. 14, the battery block 1400 includes a plurality of battery cells 700/800, an anode busbar 1310, a cathode busbar 1340, and the fuses 1420-1424 and 1450-1454. The anode terminals 710 of the battery cells 700/800 couple to the anode busbar 1310 via the fuses 1420-1424 respectively. The cathode terminals 740 of the battery cells 700/800 couple to the cathode busbar 1340 via the fuses 1450-1454. In this example embodiment, the battery cells 700/800 couple to the anode busbar 1310 and the cathode busbar 1340 through the fuses 1420-1424 and 1450-1454 respectively. In another example embodiment, the fuses 1420-1424 are omitted and the anode terminals 710 connect directly to the anode busbar 1310. In another example embodiment, the fuses 1450-1454 are omitted and the cathode terminals 740 connect directly to the anode busbar 1310.

In another example embodiment, the fuses 1420-1424 and 1450-1454 are omitted so that the anode terminals 710 of the battery cells 700/800 connect directly to the anode busbar 1310 and the cathode terminals 740 of the battery cells 700/800 connect directly to the cathode busbar 1340. The electronic switches or the fuses inside the battery cells 700/800 protect against excessive current. In another example embodiment, only one fuse 1420-1424 or 1450-1454 is used per battery cell 700/800. In another example embodiment, only one fuse 1420-1424 or 1450-1454 is used per battery cell; however, the battery cells do not include internal electronic switches or fuses, so current protection is provided by the fuses 1420-1424 or 1450-1454 and not internally inside the battery. In another example embodiment, the fuses 1420-1424 and 1450-1454 are used so that each battery cell is protected by two fuses; however, the battery cells do not include internal electronic switches or fuses.

When a battery cell 700/800 begins to fail, the current drawn through the battery cell increases beyond the current limit for the limiter 1120 (e.g., maximum current rating) of the fuses 1420-1424 and 1450-1454 connected to the battery cell that is failing. When the current passing through the failing battery cell exceeds the current limit of the limiter 1120, the limiter 1120 melts thereby burning out the fuse. Since the burned-out fuse cannot carry any current, no current passes through the failing battery cell thereby stopping the progress of the failure. For example, in the event of failure of the middle battery cell 700/800 shown in FIG. 14, the fuse 1422 and/or the fuse 1452 enters the burned-out state thereby halting flow of current through the battery cell 700/800. Stopping the flow of current through the battery cell 700/800 stops a potentially destructive rise in the temperature of the battery cell 700/800 thereby protecting the adjacent battery cells 700/800 from destruction.

Because the dimensions of the battery block are greater the dimensions of an individual battery cell, in particular an electrode, fuses may be selected from off-the-shelf components. The fuses may be integrated into a PCB that also holds the processing circuit.

### Cascade Charging

During the manufacture of batteries, individual battery cells, battery blocks (e.g., plurality of battery cells), and/or battery packs (e.g., plurality of battery blocks, plurality of battery cells) need to be charged then discharged at least once. In a process called formation, with respect to lithium-ion batteries, a battery must be charged and discharged a number of times for the battery cell to operate properly. The energy (e.g., current) used to charge the battery cells, battery blocks, or battery packs is generally drawn from the line power. In this case line power refers to power provided by a utility (e.g., power company).

In accordance with aspects the present disclosure, the first battery cell charged is charged using line power. However, when the first battery cell is discharged, the energy from the battery cell is not dissipated or returned to the utility via the power line. Instead, the discharged energy from the first battery cell is used to charge a second battery cell, the discharged energy from the second battery cell is used to charge a third battery cell and so forth. The transfer may be cyclical in that energy from the Nth battery cell may be used to charge the first battery cell a second time.

In other terms, the first battery of a plurality of batteries is charged using line power. The first battery is now referred to as the previous battery. The previous battery is discharged to provide energy to charge a next battery. The next battery is now referred to as the previous battery. A next battery for charging selected. The process of discharging the previous battery to charge the next battery continues until all of the batteries of the plurality have been charged.

The transfer of energy from one battery cell, battery block or battery pack to another battery cell, battery block or battery pack is not a fully efficient process in that there will be some energy losses during the transfer. So, if the first battery cell (e.g., previous battery cell), having a first capacity, transfers energy to a second battery cell (e.g., next battery cell), which also has the first capacity, the second battery cell will not be fully charged due to loss of energy during the transfer. In order to completely charge a second battery cell, some amount of line power will need to be used to provide some charge to the second battery cell. Line power will need to be provided to fully charge all battery cells (e.g., first, next); however, because the majority of the energy comes from the previously charged battery, the energy needed from the line power to charge the next battery cell will be less, generally significantly less, then the energy provided by the previously charged battery.

Transferring the energy from a charged battery (e.g., previous battery) to a discharged battery (e.g., next battery) reduces the amount of energy drawn from the line power and eliminates any power being returned to the line. Charging batteries by discharging one battery (e.g., previous battery) to charge another battery (e.g., battery) is referred to herein as cascade charging.

### The Charging System

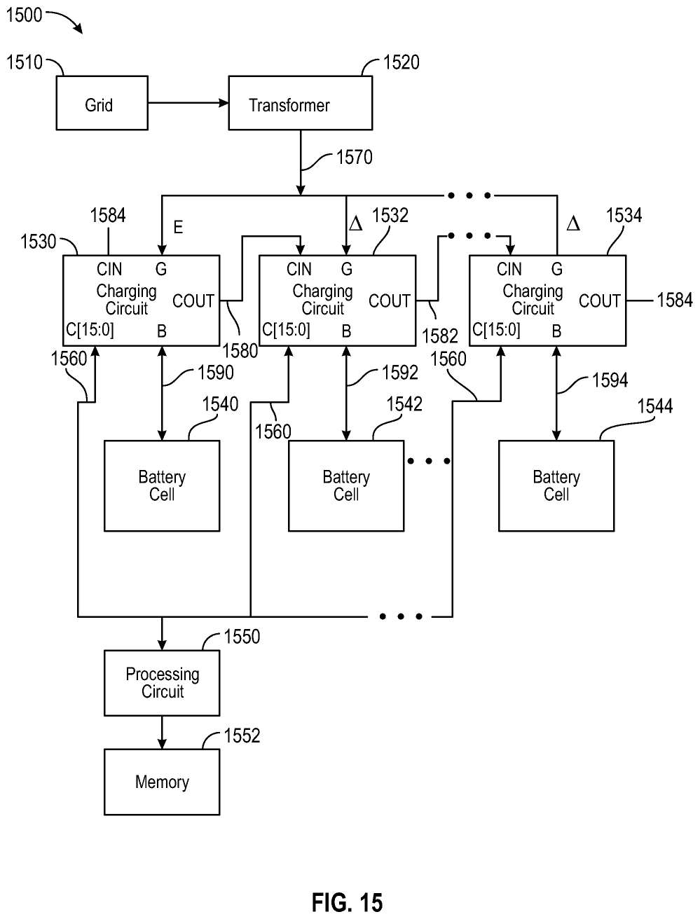

In a first embodiment, as best seen in FIG. 15, charging system 1500 uses cascade charging to charge battery cells 1540-1544. The charging system 1500 includes grid 1510, transformer 1520, charging circuits 1530-1534, processing circuit 1550 and memory 1552. The processing circuit 1550 may include a processor, a microcontroller, or any other type of circuit for computing, receiving data, providing data and/or controlling other components. The memory 1552 may include any type of semiconductor memory accessible by the processing circuit. As discussed above, grid 1510 represents line power from the utility. Transformer 1520 transforms the AC electricity from the grid 1510 to DC electricity. The DC electricity is distributed to the charging circuits 1530-1534 via line 1570 (e.g., line power).

In an example embodiment, the charging circuits 1530, 1532 and 1534 are the same. The charging circuit includes the inputs CIN and G for receiving DC energy. The charging circuit includes output COUT for providing DC energy. The charging circuit includes input/output (e.g., I/O) lines (e.g., signals, conductors) for connecting to the processing circuit 1550. While the battery cell connected to the charging circuit is being charged, DC energy (e.g., a current) flows out of B into the battery. While the battery cell connected to the charging circuit is being discharged, DC energy flows into B from the battery.

The charging circuit includes I/Os C[15:0] which represent multiple signals, some of which are input signals and the others are output signals. The I/O lines C[15:0] connect to the processing circuit 1550. In another example embodiment, there are more I/O lines (e.g., C[31:0]). The I/O lines may be organized and controlled as a bus. The charging circuit may include latches for latching input signals as provided (e.g., written) by the processing circuit 1550. The charging circuit may include latches for latching output signals for reading by the processing circuit 1550. The charging circuit may include additional control lines that are operated by the processing circuit 1550 for writing data to the charging circuit, reading data from the charging circuit or addressing the charging circuit.

Although the I/O lines (e.g., signals) from the processing circuit are described as having a specific number of bits (e.g., C0—one bit, C[15:11]—5 bits, so forth), the number of I/O lines from the processing circuit 1550 to any component in the charging circuits 1530, 1532 and 1534 may be more or fewer I/O lines than what is shown. Any number of bits may go between the processing circuit 1550 and the charging circuits or any other component of the charging system 1500. As discussed above, the I/O lines from the processing circuit 1550 may be a bus that includes read/write signals and addresses for addressing the components of the charging system 1500.

As shown in FIG. 15, with respect to charging circuit 1530, CIN connect to line 1584 from COUT of charging circuit 1534, G connects to the line 1570 from the transformer 1520, COUT connects to CIN of charging circuit 1532 via line 1580, B connects to battery cell 1540 via line 1590 and C[10:0] connect to the processing circuit 1550 via lines 1560 (e.g., bus).

With respect to charging circuit 1532, CIN connect to line 1580 from COUT of charging circuit 1530, G connects to the line 1570 from the transformer 1520, COUT connects to CIN of charging circuit 1534 via line 1582, B connect to battery cell 1542 via line 1592 and C[10:0] connect to the processing circuit 1550 via lines (e.g., bus) 1562.

With respect to charging circuit 1532, CIN connect to line 1582 from COUT of charging circuit 1532, G connects to the line 1570 from the transformer 1520, COUT connects to CIN of charging circuit 1530 via line 1584, B connect to battery cell 1544 via line 1594 and C[10:0] connect to the processing circuit 1550 via lines (e.g., bus) 1564.

All of the charging circuits receive DC power from the transformer 1520 via line 1570; however, some of the charging circuits receive less power from transformer 1520 than other charging circuits. Lines 1560, 1562 and 1564 that connect to the processing circuit 1550 may all be the same lines (e.g., 1560) if they are organized and operated as a bus, and the charging circuits are configured to interface with a bus. The dots in FIG. 15 indicate that there may be any number of charging circuits in the charging system 1500 for charging and discharging any number of battery cells. Line 1570 from the transformer 1520 and lines 1560, 1562 and 1564, or bus 1560, may extend over great distances, so the charging system 1500 could include hundreds or thousands of charging circuits for charging and discharging hundreds or thousands of battery cells. The charging system 1500 is suitable for a manufacturing environment.

In another example embodiment, the lines 1580, 1582 and 1584 connect to switches so that the COUT from one charging circuit may be switched to connect to the CIN of any other charging circuit. Switching the lines 1580, 1582 and 1584 increases the flexibility of the charging system 1500 so that battery cells may be connected to any charging circuit and operated in any sequence. The processing circuit 1550 may control the switches.

The charging system 1500 may further include a display for presenting information to a user. The processing circuit 1550 may determine where the next battery cell should be connected, or which battery cells may be disconnected because they have finished the process and instruct the user to connect or disconnect the battery cell to or from respectively a specific charging circuit. The processing circuit 1550 may also present information about the status of charging and/or discharging battery cells, voltages, currents, time remaining and/or time until an event begins.

### Charging Circuit Embodiment

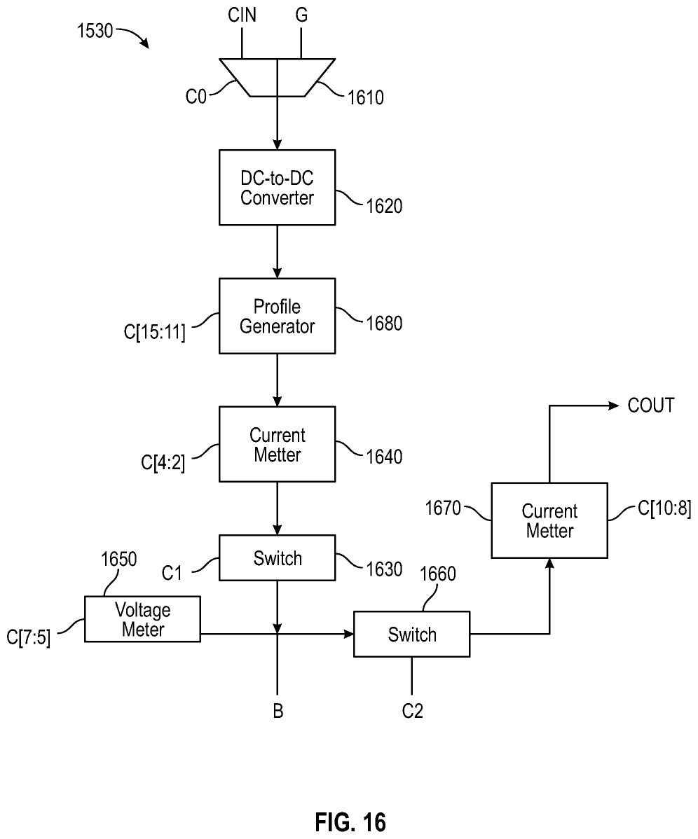

An example embodiment of the charging circuit (e.g., 1530, 1532, 1534) is shown in FIG. 16. Charging circuit 1530 is identified in FIG. 16; however, the other charging circuits 1532 and 1534 are the same. Charging circuit 1530 includes a multiplexer switch 1610, a DC-to-DC converter 1620, a switch 1630, a current meter 1640, a voltage meter 1650, a switch 1660, a current meter 1670 and a profile generator 1680.

The inputs to the multiplexer switch 1610 are CIN and G. Control of the multiplexer switch 1610 is performed by signal C0 from the processing circuit 1550. The multiplexer switch 1610 selects the source of energy used for charging the battery cell (e.g., 1540, 1542, 1544) connected to B. Referring to FIG. 15, the CIN input receives energy from discharging another battery whereas the input G receives energy from the transformer 1520 which is powered by the grid 1510.

The DC-to-DC converter 1620 conditions the energy being provided to the battery cell. It is possible that the energy in the charging system 1500 may be conditioned globally thereby eliminating the DC-to-DC converter 1620. However, the DC-to-DC converter 1620 conditions energy both from the transformer 1520 and from a discharging battery to condition all energy that reaches the battery. Conditioning the energy includes removing noise, eliminating spikes, controlling the voltage and/or the current.

The profile generator 1680 controls the voltage and/or the current that is provided to the battery cell at B. The values (e.g., amounts, magnitudes) of the voltage and/or the current provided to a battery during charging (e.g., during the time of charging, over time) is referred to as a charging profile. A charging profile may include a charging current profile, a charging voltage profile and/or charging spikes as disclosed in U.S. patent application Ser. No. 17/217,516 filed Mar. 30, 2021, which is incorporated by reference in its entirety for any purpose. The profile generator 1680 communicates with the processing circuit 1550 using signals C[15:11]. The signals C[15:11] may include signals from the processing circuit 1550 to control the profile generator 1680 and signals that provide status from the profile generator 1680 to the processing circuit.

Current meter 1640 measures the current provided by the profile generator 1680 to the battery cell at B while the battery cell is being charged. The current meter 1640 provides data regarding the amount (e.g., magnitude) of the current measured to the processing circuit 1550 via I/O lines C[4:2]. The current meter 1640 may capture the magnitude of current at any interval of time and provide the information to the processing circuit 1550. The captured data may include the time or the interval of capture. The current meter 1640 may include a buffer for buffering captured data. The processing circuit 1550 may access the buffer data via lines C[4:2].

The current meter 1670 performs the same functions and has the same capabilities as a current meter 1640 except that the current meter 1670 measures the current provided by the battery cell attached at B to COUT as the battery cell is being discharged. The current meter 1670 provides data to the processing circuit 1550 via the lines C[10:8].

The voltage meter 1650 measures the output voltage of the battery cell attached at B. The voltage meter 1650 provides data regarding the amount (e.g., magnitude, value) of the voltage measured to the processing circuit 1550 via I/O lines C[7:5]. The voltage meter 1650 may capture the magnitude of the voltage at any interval of time and provide the information to the processing circuit 1550. The capture data may include the time or the interval of capture. The voltage meter 1650 may include a buffer for buffering captured data. The processing circuit 1550 may access the buffer data via lines C[7:5].

Switch 1630 controls the flow of energy from CIN or G into the battery cell at B. The switch 1660 controls the flow of energy out of the battery cell via B. Switches 1630 and 1660 are not configured to pass energy at the same time. While one switch enables the passage of energy, the other switch blocks the passage of energy. While the battery cell is being charged, switch 1630 permits energy to pass from CIN or G to the battery cell. While the battery cell is being charged, switch 1660 stops the flow of energy from the battery cell to COUT. While the battery cell is being discharged, switch 1660 permits energy to pass from the battery cell to COUT. While the battery cell is being discharged, the switch 1630 stops the flow of energy from CIN and G to the battery cell. The switches 1630 and 1660 are controlled by the signals C1 and C2 respectively from the processing circuit 1550.

### Operation of the Charging System

The processing circuit 1550 tracks the charging and discharging of the battery cells that are being charged or discharged by charging system 1500. The processing circuit 1550 controls the operation of the charging system 1500. The processing circuit 1550 receives data from the charging circuits 1530, 1532 and 1534 to be able to provide signals to control the charging and discharging of batteries. The processing circuit 1550 receives data from the charging circuits 1530, 1532 and 1534, processes the data and provides signals to control the charging circuits 1530, 1532 and 1534 in real-time.

When the charging system 1500 first starts, the battery cells 1540-1544 are discharged. The processing circuit 1550 may select any one of the battery cells 1540, 1542 or 1544 to be charged first. In this example, the processing circuit 1550 charges the battery cell 1540 first. Since the battery cell 1544 is not charged, the battery cell 1544 cannot provide energy to the charging circuit 1530 via line 1584. So, the processing circuit 1550 selects the transformer 1520 to be the source of energy to charge the battery cell 1540. In this example, the battery cell 1540 is charged with a first amount of energy from the grid 1510 which is referred to as E. The amount of energy E represents the amount of energy stored by a battery cell (e.g., 1540, 1542, 1544) after it has been charged.

Once battery cell 1540 is charged, the processing circuit 1550 may configure the charging system 1500 to charge the battery cell 1542 (e.g., next battery cell). Since the battery cell 1540 has been charged, the battery cell 1540 (e.g., previous battery cell) may be discharged to provide energy to charge the battery cell 1542. The processing circuit 1550 configures the charging circuit 1530 to transfer energy from battery cell 1540 to CIN of the charging circuit 1532 via line 1580. The amount of energy transferred from battery cell 1540 to the battery cell 1542 will be the amount of energy E minus any losses, which are referred to as delta.

Once the energy from the battery cell 1540 has been transferred to the battery cell 1542, the battery cell 1542 is not fully charged because of the amount of energy, delta, that has been lost. The processing circuit 1550 configures the charging circuit 1532 to receive a second amount of energy from the transformer 1520 via G. The energy from the transformer 1520 is used to finish charging the battery cell 1542 so that it stores the amount of energy E. Because the battery cell 1540 has already provided the amount of energy E− delta to the battery cell 1542, the transformer 1520 need provide only the amount of energy delta to finish charging the battery cell 1542 to store the amount of energy E. The value delta, which represents losses in the charging system 1500, may also include any losses experienced by transformer 1520 while providing energy to a battery cell. Once the battery cell 1542 has been charged to store the amount of energy E, the charging system 1500 has received the amount of energy E+ delta from the grid 1510.

The processing circuit 1550 may configure the charging system 1500 to charge a next battery cell (e.g., 1544). Battery cell 1542 (e.g., previous battery cell) will be discharged to provide the amount of energy E− delta to the next battery being charged. The battery being charged will also receive the amount of energy delta from the grid to finish charging the next battery to store the amount of energy E. By the time the third battery cell has been charged, the amount of energy received from the grid 1510 is E+2(delta). In a system that charges N battery cells, by the time the last battery cell has been charged, the amount of energy received from the grid 1510 is E+(N−1)(delta).

In other words, the amount of energy provided by the grid 1510 for charging battery cells after the first battery cell is only the amount needed to make up for losses in the charging system 1500. If the energy from a charge battery were not transferred (e.g., cascaded) to an uncharged battery and was simply dissipated, the amount of energy required from the grid 1510 to charge N batteries would be the amount of energy N(E) (e.g., N multiplied by E), which means N times the total amount of energy required to charge one battery cell using the charging system 1500. Cascading the energy from one battery to another battery can save significant amounts of energy and cost.

The above embodiment of the charging system 1500 shows battery cells being charged sequentially. One battery cell is discharged to charge another battery cell. The concept of cascade charging is not limited to serial operation of the charging system 1500. In another embodiment of the charging system 1500, several battery cells are charged with energy from the grid 1510. Once the several battery cells are charged, those battery cells may be discharged to charge other battery cells at the same time (e.g., in parallel). The cost of charging the several battery cells is the number of battery cells F times the amount of energy E (e.g., F times E). However, the subsequent battery cells (e.g., next battery cells) that are charged cost the amount of energy delta for each battery, so if S subsequent (e.g., next) battery cells are charged, the cost and power from the grid 1510 would be S times delta. Even though more power is taken from the grid 1510 at the beginning of the process two charge the first group of battery cells, battery cells may be charged and discharged in parallel thereby saving time which may justify the increased cost of energy from the grid 1510.

Further, in another example embodiment, when all battery cells have been charged, the energy remaining in the last battery cells may be returned to the grid 1510, if permitted by the utility company, thereby reducing the overall cost of energy from the grid 1510. In another example embodiment, the charging system 1500 does not return power to the grid. Any power remaining in one or more battery cells at the end of the process would need to be dissipated. However, the processing circuit 1550 may control the process so that multiple batteries may be discharged and charged in parallel until the end of the process when the processing circuit 1550 may change to serial discharging and charging so that the amount of energy remaining at the end of the process, which is dissipated, is the amount of charge on only one battery cell.

In the embodiment of charging system 1500 discussed above, the charging system is described as charging or discharging battery cells. The charging system 1500 may also charge and discharge battery blocks and/or battery packs. So, in the above description, the word battery cell may be replaced with the word battery block or battery pack without changing the function or operation of the charging system except for the amount of energy and time involved.

The processing circuit 1550 may be configured to control the charging system 1500 for charging and discharging battery cells, battery blocks and or battery packs at the same time. In other words, the capacity of the storage device connected to the various charging circuits need not be the same. For example, a battery cell could be connected to charging circuit 1530, a battery block connected to charging circuit 1532 and a battery pack connected to charging circuit 1534. The processing circuit 1550 is informed of the storage capacity of each item attached to B of each charging circuit. The processing circuit 1550 may plan and control the transfer of energy from one or more battery cells to a battery block or battery pack, or the transfer of energy from a battery block or a battery pack to one or more battery cells. The processing circuit 1550 may control the charging process so that additional amount of energy from the grid 1510 are used when the amount of energy stored by battery cells, battery blocks and/or battery packs is insufficient to cascade to the remaining battery cells, battery blocks and/or battery packs. However, the concept remains the same in that discharging one battery cell, battery block and/or battery pack to charge one or more battery cells, battery blocks and/or battery packs reduces the amount of energy taken from the grid 1510 and thereby the cost of energy used in the process.

System to Protect Adjacent Battery Cells or Battery Blocks from Damage

Battery packs, battery blocks and battery cells are discussed above. In the example embodiments of the system for protecting adjacent battery cells or battery blocks, it is assumed that the battery cells and battery blocks do not include the electronic switches or fuses discussed above. It is possible for the battery cells and battery blocks of the embodiment of this system to include the protection of the electronic switches and/or fuses in addition to control of the cooling system to protect adjacent battery cells or battery blocks. Including electronic switches and/or fuses in the battery cells and/or battery blocks described for this system would enable the cooling system to better protect the battery cells in your battery blocks from harm.

As discussed above, failure of a battery cell generally results in the battery cell drawing a high current. Drawing the high current causes the battery cell to overheat. The excessive heat may destroy the functioning (e.g., non-failing) battery cells that are proximate to the battery cell that is failing. The same applies to the battery blocks used to form a battery pack. A battery cell and a battery block may fail thereby causing excessive heat that destroys some or all of the battery cells in the battery block or the battery blocks in the battery pack. The excessive heat in the failing battery sell or battery block may affect adjacent battery blocks causing them to also fail.

A battery pack, which in this embodiment comprises a plurality of battery blocks, may include a cooling system. The cooling system distributes a medium that extracts heat from the battery blocks. As the medium extracts heat from the battery blocks, the temperature of the medium increases. The cooling system receives the heated medium and removes heat from the medium in attempt to maintain the medium at a constant temperature and thereby the battery blocks at a constant temperature which is below, or significantly below, the temperature that may damage the battery block.

The cooling system may include one or more detectors that detect the physical characteristics of the various battery blocks and/or the individual battery cells of a battery block. The physical characteristics may include voltage, current and/or temperature. The detectors report the captured data regarding the physical characteristics to the cooling system. Responsive to the capture data, the cooling system adjust the flow of medium toward the battery blocks that are proximate to the battery block that is or is likely to experience a failure. In the event of the failure of a battery block, the cooling system may increase the flow of medium toward the adjacent battery blocks in an attempt to protect them from the increased heat from the failing battery block.

The detectors are configured to detect the voltage across the battery block, the current drawn/provided by a battery block, the temperature of a battery block and/or one or more battery cells of the battery block in order to detect the imminent failure of any one battery block and/or battery cell. The detector provides the detected data to the cooling system. If the cooling system detects, in accordance with the capture data, an imminent failure of a battery block or a battery cell, the cooling system provides an increased amount of cooling medium to the failing battery block and/or the battery blocks adjacent to the failing battery block to reduce the likelihood of damage to the adjacent battery blocks. Once the battery block or the battery cell has completed its failure, the cooling system, in accordance with the capture data, returns the flow of cooling medium to normal levels.

### Battery Pack

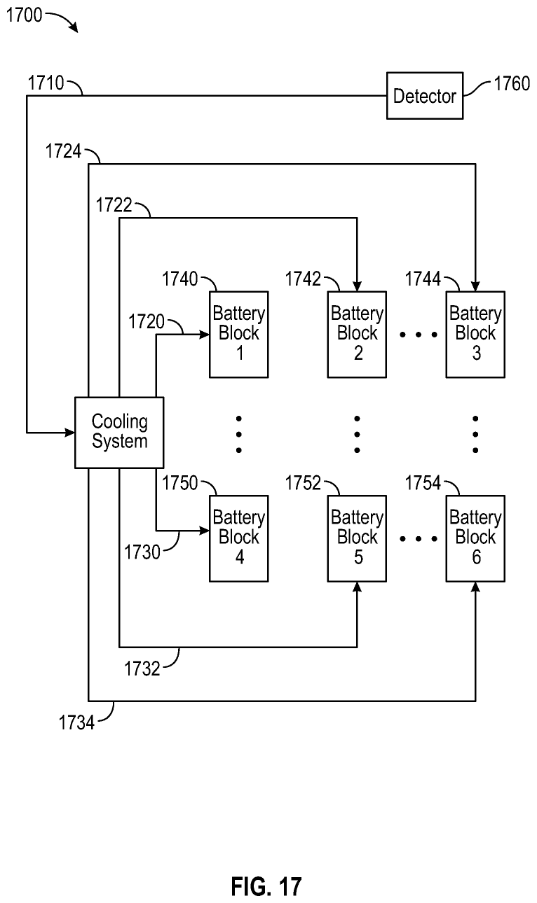

In an example embodiment, referring to FIG. 17, a battery pack 1700 includes battery blocks 1740-1744, 1750-1754. The dots in FIG. 17 indicate that there may be many battery blocks. The battery blocks are electrically coupled to each other in series and/or in parallel. The battery blocks are positioned in a container that holds a cooling medium. The cooling medium may be liquid and/or gas. The battery blocks are surrounded by (e.g., submerged in) the cooling medium. The battery pack 1700 provides a current from the battery blocks during discharge of the battery pack 1700. A current is provided to the battery pack 1700 and thereby to the battery blocks to recharge of the battery blocks. In a preferred embodiment, the cooling medium is a liquid.

### Cooling System

The battery pack 1700 includes the cooling system 1710. The cooling system 1710 may heat or cool the cooling medium that is circulated around the battery blocks 1740-1744, 1750-1754. The cooling system 1710 is adapted to provide a plurality of outward flows 1720-1724, 1730-1734 of the cooling medium toward specific battery blocks. A system of ducts with dampers may be used control the outward flow of the cooling medium toward specific battery blocks. The volume of cooling medium of one outward flow may be different from the volume of the cooling medium of another outward flow. The temperature of the cooling medium of one outward flow may be different from the temperature of the cooling medium of another outward flow. The rate of flow of the cooling medium of one outward flow may be different from the rate of flow of the cooling medium of another outward flow. The cooling system 1710 may adjust the volume, the temperature and/or the rate of flow of the cooling medium of one outward flow, as opposed to any other outward flow, to heat or cool one battery block more than any other battery block. The cooling system 1710 may heat or cool one or more battery blocks independently of one or more other battery blocks.

The return of cooling medium to the cooling system 1710 may be accomplished by general circulation or by directed return. In general circulation, the cooling system 1710 has one or more inlets that receive cooling medium from the pool of cooling medium that surrounds the battery blocks 1740-1744, 1750-1754. In general circulation, the return medium is collected by the cooling system 1710 as it passes proximate to an inlet.

In a directed return, the cooling system 1710 is configured to remove cooling medium away from specific battery blocks. A system of ducts with dampers may be used to form and control the return flow of cooling medium from specific battery blocks. For clarity of presentation, the return flows are not shown in FIG. 17. The volume and/or rate of cooling medium of one return flow may be different from the volume and/or rate of cooling medium of any other return flow or of the outward flow that services the same battery block.

The cooling system includes a processing circuit configured to receive data from the sensors of the detector 1760 and to control the outward and return flows of cooling medium in accordance with the data. The sensors of the detector 1760 may capture data regarding the physical characteristics of the battery blocks in real-time or at intervals that are sufficiently frequent to be able to detect an imminent failure of a battery block. The sensors of the detector 1760 may provide the capture data to the processing circuit in real-time or at intervals. The sensors of the detector 1760 and/or the processing circuit may include buffers for storing information for rapid transfer. The sensors of the detector 1760 may be connected to the processing circuit of the cooling system 1710 via individual lines (e.g., conductors) that may provide analog real-time data. The sensors of the detector 1760 may be connected to the processing circuit via a bus that communicates with all of the sensors of the detector 1760. Sensors that communicate via the bus transfer digitized data to the processing circuit.

In an example embodiment, the sensors of the detector 1760 eight have and an individual address so that the processing circuit may communicate with a selected sensor. The address identifies the sensor. The address of the sensor may also identified the physical location of the sensor in the battery pack 1700. In another example embodiment, the sensors may include an ID (e.g., number) that identifies the sensor. The sensor may provide the ID to the processing circuit along with captured data. The processing circuit may use the ID to identify the physical location of the sensor in the battery pack 1700. The processing circuit may control the rate of data capture by a sensor to be able to capture data at a higher rate, when needed, to better detect imminent failure.

As the processing circuit receives data from the sensors, the processing circuit analyzes the data in real-time or in near real-time to be able to detect an imminent failure in a timely manner to be able to control the flows of the cooling medium. The processing circuit is configured to process data from all the sensors within a single period of time. For example, if each sensor provides captured data every second and there are 100 sensors, the processing circuit is configured to process the data from the 100 sensors in one second. Once a battery cell begins to fail, the temperature can rise to a destructive level within milliseconds. The cooling medium positioned between the battery blocks prior to start of the failure may slow the spread of the destructive heat to adjacent battery packs; however, the processing circuit likely should be able to process data from all the sensors somewhere between 10 and 1000 times per millisecond in order to detect failures in a timely manner.

The imminent or the failure of a battery block may include detecting a rate of temperature increase. For example, if the temperature of the battery block or the battery cell increases between 10° C. and 100° C. in a millisecond or less, failure of the battery block with a battery cell is likely imminent. Upon detecting imminent failure, the processing circuit immediately configures the outward and return flows to protect the battery blocks proximate to the battery block that is beginning to fail.

Processing data from the sensors includes detecting and remembering an average temperature, voltage or current for a battery block over time. Processing data includes finding a difference between a current temperature, voltage or current and an earlier temperature, voltage or current. Processing data includes finding a rate of change of temperature, voltage or current. Imminent failure may be indicated by a change in the temperature, the voltage or the current of a battery cell or battery block in the range of 10% to 100%. Processing data may include detecting a resistance of a battery cell and/or a battery block. For example, the sensors may detect the voltage across a battery cell or battery block and the current being sunk or sourced by the battery cell or the battery block to calculate the resistance of the battery block. A change in resistance over time, especially a rapid change resistance, indicates a likely imminent failure.

### Detector

The detector 1760 may include a single sensor (e.g., detector) or a plurality of sensors (not shown). The detector 1760 includes a variety of different types of sensors. For example, as discussed above, the detector 1760 include sensors that detect voltage, current, temperature, the volume of flow and the rate of flow. Preferably, the sensors of detector 1760 are positioned at different physical locations throughout the battery pack. The sensors may be arranged to detect the operating conditions of each battery block 1740-1744, 1750-1754 respectively. The sensors may be arranged to detect the operating conditions of some of the battery cells of a battery block. For example, sensors may be positioned inside a battery block to sense the voltage, the current, and/or the temperature of particular battery cells of the battery block. For example, a battery block may include a temperature sensor positioned close to the battery cells positioned at the physical center other battery block and/or the battery cells positioned at the edge of the battery block. Detecting the temperature at the center and/or at the edges of the battery block provides data as to the spread of a higher temperature through the battery block. Further, when the temperature of battery cells at the edge of the battery block begins increasing in temperature, the likelihood of higher temperatures spreading to proximate battery blocks is likely.

Generally, the failure of a battery block or a battery cell results in a dramatic increase in the temperature of the battery block or the battery cell. The increase in the temperature may be so large as to affect nearby battery blocks or battery cells that are not failing. An increase in the temperature of one battery block or one battery cell due to the failure may be so significant that it destroys (e.g., overheats, melts) proximate battery blocks or battery cells. As discussed above, when imminent failure is detected, the effect on proximate battery blocks by the anticipated increase in temperature may be mitigated by increasing the amount of outward flow, increasing the rate of outward flow, and/or decreasing the temperature of the cooling medium that is directed toward the battery packs that are approximate to the battery pack that is failing.

Once the battery block or battery cell has completed its failure and its temperature has returned to the normal operating temperature of the battery pack 1700, the processing circuit of the cooling system may reduce the outward flow of cooling medium directed toward the failed battery block and/or the proximate battery blocks.

### Cooling System in Operation

In an example of the operation of the example embodiment, the battery blocks 1740-1744 and 1750-1754 of the battery pack 1700 are submersed in a liquid cooling medium (not shown). The outward flows 1720-1724 and 1730-1734 are directed toward the battery blocks 1740-1744 and 1750-1754 respectively. The ducts that direct the outward flows 1720-1724 and 1730-1734 are not expressly shown. In this example embodiment, the cooling system also includes ducts for return flows from each battery block 1740-1744 and 1750-1754; however, the return flows are not shown.

Thresholds for temperature, voltage and/or current may be set for identifying imminent failure of a battery block. Thresholds for rate of change of temperature, voltage and/or current may be set for identifying imminent failure of a battery block. The processing circuit of the cooling system 1710 receives data from the sensors of the detector 1760. The processing circuit processes the capture data from the sensors as discussed above.

In this example of operation, the processing circuit detects a rate of change of the temperature of the battery blocks, the voltage provided by the battery blocks and/or the current drawn or sourced by the battery blocks. The processing circuit identifies a change in temperature, voltage or current in excess of 10% over between 10 and 100 sample periods (e.g., 10 microseconds to 100 microseconds for 1 microsecond sample period) as a possible start of a failure of a battery block. A change in excess of 20% is a threshold at which the microprocessor begins to change outward flows to protect proximate battery blocks.

For example, assume that the processing circuit detects a change in the operation of the battery block 1752 greater than the threshold. The processing circuit immediately (e.g., within microseconds or a millisecond) instructs the cooling system 1710 to alter outward flow 1730 to provide additional cooling capacity to battery blocks 1750 and any battery block proximate to the right of battery block 1752, referring to FIG. 17. Further if the battery block 1742 is proximate to the battery block 1752, the processing circuit instructs the cooling system 1710 to provide additional cooling capacity to battery block 1742. The battery blocks 1740 and any battery block to the right of battery block 1742 that is adjacent may also need increased cooling capacity.

In this example, the cooling system 1710 increases the volume of the outward flows directed toward the above battery blocks and the rate of flow of the cooling medium. If possible, the cooling system 1710 further decreases the temperature of the cooling medium directed at the above battery blocks. The sensors continue to monitor the proximate battery blocks. If the failure, particularly increased temperature, begins to spread to the proximate battery blocks, the processing circuit may direct the cooling system 1710 to increase the flow and/or the rate of other outward flows in attempted to contain the spread of the increased temperature.

After the failure of the battery block 1752 is finished, the processing circuit attempts to detect the status of the remaining battery blocks. The sensors in and around the battery block 1752 may have been destroyed by the increased heat of the failure, so the processing circuit collects data from the sensors of the proximate battery blocks to determine whether the proximate battery blocks are still functioning or if they too are providing indications of failure. Once the sensors provide data that indicates a stable system, the processing circuit instructs the cooling system 1710 to decrease the outward flows to bring the system into a stable operating state.

Once the battery block 1752 has been destroyed, the processing circuit of the cooling system 1710 may reduce the outward flow 1732 toward and the return flow from the battery block 1752 and increase the outward flow to the remaining battery blocks. Alternatively, the processing circuit may instruct the cooling system 1710 to reduce all flow to or from the battery block 1752 because heat is no longer being produced by the battery block 1752.

### Afterword

The foregoing description discusses embodiments (e.g., implementations), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A system for charging a first provided battery and a second provided battery, the system comprising:
a processing circuit;
a first charging circuit having a first input (CIN), a second input (G), a first node (B) and a first output (COUT); and
a second charging circuit having a third input (CIN), a fourth input (G), a second node (B) and a second output (COUT); wherein:
the first node (B) connects to the first provided battery;
the second node (B) connects to the second provided battery;
the first input (CIN) connects to the second output (COUT);
the first output (COUT) connects to the third input (CIN);
the second input (G) and the fourth input (G) connected to a provided power line from a provided utility;
to charge the first provided battery, the processing circuit configures the first charging circuit to receive energy via the second input (G) from the provided power line, whereby the first provided battery is charged to store a first amount of energy (E); and
to charge the second provided battery, the processing circuit configures:
the first charging circuit to discharge the first provided battery to provide the first amount of energy E to the second charging circuit via the first output (COUT) and the third input (CIN); and
the second charging circuit to charge the second provided battery with the first amount of energy (E) from the first provided battery and a second amount of energy (delta) from the provided power line, the second amount of energy (delta) being energy lost in the first charging circuit and the second charging circuit.

2. The system of claim 1 wherein a total amount of energy received from the provided utility is the first amount of energy (E) plus the second amount of energy (delta).

3. The system of claim 1 wherein to charge the first provided battery, the processing circuit further configures:
the first charging circuit to:
not receive any energy via the first input (CIN); and
not provide any energy via the first output (COUT); and
the second charging circuit to:
not provide any energy to the second provided battery; and
not provide any energy via the second output (COUT).

4. The system of claim 1 wherein to charge the second provided battery, the processing circuit further configures:
the first charging circuit to not provide any further energy to the first provided battery; and
the second charging circuit to not provide any energy via the second output (COUT).

5. The system of claim 1 wherein the first charging circuit and the second charging circuit include a DC-to-DC converter respectively, the DC-to-DC converter is configured to condition the energy provided to charge the first provided battery and the second provided battery respectively.

6. The system of claim 1 wherein the first charging circuit and the second charging circuit include a profile generator respectively for providing a charging profile to charge the first provided battery and the second provided battery respectively.

7. The system of claim 1 wherein:
the first charging circuit includes a first current meter and a second current meter;
the first current meter is configured to measure an amount of current provided to charge the first provided battery; and
the second current meter is configured to measure an amount of current provided by the first provided battery to the second provided battery.

8. The system of claim 7 wherein the first current meter and the second current meter are configured to report the amount of current respectively to the processing circuit.

9. The system of claim 1 wherein:
the first charging circuit and the second charging circuit include a voltage meter respectively; and
the voltage meter is configured to measure a voltage across the first provided battery and the second provided battery respectively.

10. The system of claim 9 wherein the voltage meter of the first charging circuit and the second charging circuit respectively are configured to report the voltage to the processing circuit.

11. A system for charging a plurality of provided batteries, the system comprising:
a processing circuit; and
a plurality of charging circuits, each charging circuit of the plurality of charging circuits connects to one battery of the plurality of provided batteries respectively; wherein:
(a) to charge a first battery of the plurality of provided batteries, the processing circuit configures a first charging circuit associated with the first battery to receive energy from a provided power line from a provided utility to charge the first battery with a first amount of energy;
(b) after the first battery is charged, the first battery is referred to as a previous battery and the first charging circuit is referred to as a previous charging circuit;
(c) to charge a next battery of the plurality of provided batteries, the processing circuit configures:
the previous charging circuit to discharge the previous battery to provide the first amount of energy from the previous battery to a next charging circuit associated with the next battery; and
the next charging circuit to charge the next battery with the first amount of energy from the previous battery and a second amount of energy from the provided power line from the provided utility, the second amount of energy being energy lost in the previous charging circuit and the next charging circuit;
(d) after the next battery is charged, the next battery is referred to as the previous battery and the next charging circuit is referred to as the previous charging circuit; and
(e) repeating steps (c) through (d) until a last battery of the plurality of provided batteries of provided batteries is charged.

12. The system of claim 11 wherein after the last battery has been charged, a total amount of energy received from the provided utility is the first amount of energy plus ((a total number of batteries of the plurality of provided batteries−1)*(the second amount of energy)).

13. The system of claim 11 wherein:
each charging circuit of the plurality of charging circuits includes a DC-to-DC converter respectively; and
the DC-to-DC converter is configured to condition the energy provided to each charging circuit respectively to charge the battery associated with the respective charging circuit.

14. The system of claim 11 wherein:
each charging circuit of the plurality of charging circuits includes a profile generator respectively; and
the profile generator is configured to provide a charging profile to charge the battery associated with the respective charging circuit.

15. The system of claim 11 wherein:
each charging circuit of the plurality of charging circuits includes a voltage meter respectively; and
the voltage meter is configured to measure a voltage across the battery associated with the respective charging circuit.

16. The system of claim 11 wherein:
each charging circuit of the plurality of charging circuits includes a current meter respectively; and
the current meter is configured to measure an amount of current provided to charge the battery associated with the charging circuit.

17. The system of claim 11 wherein:
each charging circuit of the plurality of charging circuits includes a current meter respectively; and
the current meter is configured to measure an amount of current provided by the previous charging circuit to the next charging circuit.
